(19) United States
(12) Patent Application Publication
(10) Pub. No.: US 2025/0292274 A1
(43) Pub. Date: Sep. 18, 2025

(54) AUTOMATED CONTENT GENERATION AND DESTINATION IDENTIFICATION

(71) Applicant: HONEYWELL INTERNATIONAL INC., Charlotte, NC (US)

(72) Inventors: Ankit Singh, Apex, NC (US); Arun Ramasubrahmanyan, Burlington, NJ (US); Abhishek Hiremath, Houston, TX (US); Waad Subber, Niskayuna, NY (US); Timothy Sneed, Beachwood, NJ (US)

(21) Appl. No.: 18/607,594

(22) Filed: Mar. 18, 2024

(51) Int. Cl. G06Q 30/0203; G06F 40/205

(52) U.S. Cl. CPC G06Q 30/0203; G06F 40/205

(57) ABSTRACT

Techniques for generating content and identifying a destination are disclosed. Content associated with a machine-readable document is parsed to identify a set of keywords. The document includes sections, each associated with a topic linked. Each of the topics has an associated preference parameter. An interrelationship metric and, subsequently, a linkage status is determined for each keyword to filter relevant keywords and model questions. Each question is then classified into one or more clusters, each cluster being linked to a topic. A destination, from amongst a plurality of destinations, is then identified for receiving the questions from one or more clusters. The destination is identified based on the preference parameter, where each of the destinations is linked with the preference parameter associated with each of the topics, where the topics are further linked with the clusters. A questionnaire delivery information is then generated to deliver the questions to the identified destination.

### BACKGROUND

Certain organizations may develop and offer various services in the form of products, platforms, and/or other possible modes to their customers. In many cases, the organizations may also generate or create different types of machine-readable documents that may be associated with such services. Examples of machine-readable documents may include, but are not limited to, analytical reports, review reports, annual product quality review (APQR) reports, finance-related reports or statements, sales reports, datasheets, manuals, project reports, and catalogues. The documents, in one example, may include informational content that may be associated with one or more products and/or services associated with the organization. For instance, the content may be textual information, non-textual information, or a combination thereof. The content may be related to different topics, for example, features, modifications, characteristics, performance, results, quality, sales, specification, and other workflow-related information that may be associated with the products and/or services.

### BRIEF DESCRIPTION OF DRAWINGS

FIGS. 1A to 1C illustrate a computing environment comprising a system, according to an example implementation,

FIGS. 2A to 2C illustrate a machine-readable document, according to an example implementation.

FIG. 3 illustrates a block diagram of the system, according to an example implementation.

FIG. 4 illustrates a computing environment comprising the system, according to another example implementation.

FIG. 5A illustrates a questionnaire having questions, according to one example implementation.

FIG. 5B illustrates a table indicating an exemplary association of preference parameters with one or more topics, according to one example implementation.

FIG. 5C illustrates a table indicating an exemplary association between the questions and the topics, according to an example implementation.

FIG. 5D illustrates a table indicating exemplary links between clusters, the topics, and the questions, according to an example implementation.

FIG. 5E illustrates a table indicating an exemplary link between a plurality of destinations and the preference parameters, according to one example implementation.

FIGS. 6A and 6B illustrate a method for assisting generation of content and identification of a destination for the generated content, according to an example implementation of the present subject matter.

FIGS. 7A and 7B illustrate a method for generating content and identification of the destination for the generated content, according to another example implementation of the present subject matter.

FIG. 8 illustrates a non-transitory computer-readable medium for generating, or at least assist in generation of, content and identifying the destination from amongst a plurality of destinations, in accordance with an example of the present subject matter.

### DETAILED DESCRIPTION

Typically, organizations may develop one or more machine-readable documents that may provide different types of information. In one example, the intent of such documents may be to provide information related to products and/or services, progress associated with the organization, internal modifications in structure or management associated with the organization, and other news or updates. For example, the machine-readable documents may be analytical reports that may be indicative of the performance of an organization's operation(s). Other examples of such documents may include, but are not limited to, review reports, annual product quality review (APQR) reports, finance-related statements, sales reports, datasheets, Food and Drug Administration (FDA) reports, manuals, and catalogues.

The documents may include informational content embedded therein, to convey or indicate the intent of the documents. For instance, the content may be information associated with different topics, such as features, modifications, characteristics, performance, results, quality, sales, specifications, and workflows that may be associated with the products and/or services. The information may be in textual format, non-textual format, or a combination of both and may indicate what the document intends to covey. For example, the documents may include the content or information in different formats, text, images, tables, charts, graphs, templates, advertisements, dashboards, and a combination thereof. In one example, the document may be a machine-readable data file having the content embedded therein.

In one example, the documents may further include a plurality of sections or chapters, each having a corresponding theme or topic. For example, the content of the document may be distributed amongst a plurality of sections or chapters. Distribution of the content may be based on, in one example, the topic with which the content may be associated. That is, the content is organized into sections or chapters, each corresponding to a specific topic, such as product features or sales performance. Such division may facilitate in establishing easy and/or direct reference with the information relevant, for example, to a user or a reader. Based on the topic of the content, the content may accordingly be associated with the corresponding sections. In another example, the content may be in a non-sequential order without division into distinct sections. For example, content associated with different topics may be included in the document in any other order or fashion.

Each of the one or more sections may be associated with topics, for example, product quality, process quality, description of the product, modifications in the product, certifications of the products, and the like. In one example, one of the sections may also be a questionnaire section that includes one or more questions associated with the content. For example, the questions may be frequently asked questions and/or questions that may be added to address common/general queries associated with the performance of an organization or a particular department associated with the organization. In one example, the questions may be related to products and/or services being offered or developed by the organization. In another example, the questions may be included in one of the sections to provide insight into the content embedded in the document.

Also, the document may include, in one example, answers to the questions embedded within the document. The answers may be, in one example, provided by a user or an expert associated with the topic. For example, if the question is associated with the quality of a product, the modelled question may be answered by an individual concerned or associated with the quality department of the product.

Typically, preparation of the documents is a manual and time-consuming process that requires efforts and involvement of multiple concerned individuals or expert individuals. Examples of such individuals or users may include, but are not limited to, department leads, review project managers, approvers, business admins, developers, quality assurance agent(s), and support staff of the product and/or services. In one example workflow of manual preparation of the machine-readable document, a review project manager may assign expert individuals or agents to prepare the document. A business admin may then configure the sub-sections or chapters, such as names of chapters, data sources from which the content for the chapters may be derived, charts, visualization configurations for the chapters, etc. The concerned individuals from different departments may then start adding and/or updating the content for each of the sections in order to create and complete the document.

While the individuals may use different tools, for example, business intelligence (BI) tools, as sources for preparing and finalizing the content, the individuals still have to manually identify and associate different content with their respective sections of the document to generate appropriate content in each of the plurality of sections, such as the questionnaire section having the questions therein. Manual preparation of the documents and/or the sections may thus introduce several challenges. For example, manual preparation of the questionnaire section may be a tedious task, consuming a lot of time of the individuals as they have to manually comb through the content of the documents and accordingly frame the questions. As a result, the time required for preparing the documents and/or the sections increases considerably. Also, as more time may be required, computing resources may be engaged for more time in the process or document preparation. Further, manual preparation of the documents and/or the sections may consume a considerable amount of computing resources as the individuals may have to repeatedly call/access multiple databases to access and/or obtain the content and repeatedly access the documents to embed or update the content in different sections of the document. Thus, manual preparation of the documents is a time-consuming and tedious task, consuming a considerable amount of computing resources.

Further, for the document to have an acceptable level of quality and accuracy, a suitable skilled professional, such as an expert individual having at least some knowledge related to the topic, is required to be identified for associating and/or embedding the appropriate content in the corresponding sections. Even if the document is prepared by such skilled professionals, the quality of the document is highly dependent on the skill level of the individual, as different individuals may have varying skill levels, thereby, affecting the quality and accuracy of the document. For example, since different individuals may have knowledge or experience with different topics, it may be desirable to provide question(s) related to different topics to individuals being experts in such corresponding topics to receive acceptable or appropriate responses for the question(s). Thus, for the document to have an acceptable quality and accuracy of the content, the identification of a correct or appropriate individual is necessary.

Typically, the identification of expert individuals is a manual process. For example, each of the questions may have to be manually channeled or sent to the respective expert individuals. The task of manually preparing the document may thus become complicated as the individuals, for example, individuals capable or responsible for answering the questions, are required to be manually identified. That is, manually preparing the document is complex, as it involves identifying and assigning individuals with the appropriate expertise to answer specific questions within the document. The complication may further increase with the increase in the number of topics, size, and complexity of the content. As the document expands to cover more topics and the content grows in volume and intricacy, identifying the right experts for each section becomes increasingly challenging. Further, in case the questions are channeled to an unintended individual, for example, an individual who is not an expert to address the question, retransmission of the questions may then have to be initiated, thereby consuming more computing and network resources and further delaying the process of preparation or finalization of the document. Also, if the questions are provided to the unintended individual, the probability of receiving an appropriate or accurate response to the questions may be compromised.

Further, as the individual may not be an intended expert user, say for a particular topic, it may be possible that data, for example the content of the document, may not get efficiently assessed or scrutinised up to an appropriate extent to derive a suitable response. As a result, the non-expert individual may fail to efficiently utilize the data and provide an insightful conclusion or overview of the content, thereby compromising the efficiency of data utilization and limiting the extent up to which the data could have been utilized, for instance, if the data would have been provided to a concerned expert individual. Therefore, the accuracy of the document, the overall process of preparing the document, and utilization of data may be compromised.

Further, with advancements in technology, automation solutions have been developed to assist in the preparation of the documents and/or sections. The automation solutions may analyse the machine-readable documents and accordingly generate the one or more sections, such as the questionnaire section. However, such solutions may still fail to completely address the existing challenges. For example, the generated questionnaire section may include static questions. That is, the generated questionnaire section may include specific questions that may majorly be directed towards a few factors or topics, such as product quality. A user, for example, a reader going through the prepared document may thus only be able to draw limited conclusions or insights from such questions that are limited to only a few topics. Thus, the static questions may fail to provide a broader and insightful overview of the document and the content embedded in the document. Further, such solutions fail to determine the expert individuals or agents to whom the questions must be directed, and the process may still require manual intervention for directing the questions to an appropriate destination, for example, one or more expert individuals.

The present subject matter describes approaches for generation of content and destination identification for a machine-readable document. In one example, the machine-readable document may include content distributed among one or more sections, where each of the one or more sections may be associated with one or more topics linked to the content. Each of the one or more topics may have a preference parameter linked therewith. In one example, the preference parameter may indicate a significance of each of the one or more topics. The significance may be indicated, in one example, by a level of criticality that may be associated with each of the one or more topics.

Further, in one example, the content associated with the machine-readable document may be parsed to identify a set of keywords. The set of keywords may be, in one example, the most frequently present keywords in the content. An interrelationship metric may then be computed for each keyword present in the identified set of keywords. In one example, the interrelationship metric may be computed based on a correlation between each keyword and each of the one or more topics. The correlation may be, for example, either a simple correlation or a complex correlation. In the simple correlation, for instance, each keyword present in the identified set of keywords may have a direct relationship with at least one of the one or more topics. In the complex correlation, each keyword may be correlated, for instance, with at least one intermediary keyword present in the identified set of keywords. The at least one intermediary keyword may thus create a linked relationship with at least one of the one or more topics.

A linkage status may then be determined for each keyword present in the identified set of keywords. The linkage status may indicate, in one example, a potential relevance between each keyword, present in the identified set of keywords, and a topic from amongst the one or more topics. In one example, the linkage status may be determined based on a comparison between the interrelationship metric, computed for each keyword present in the identified set of keywords and a threshold linkage score. The threshold linkage score, in one example, may be a predefined score. A relevant set of keywords may then be filtered from the identified set of keywords. The filtering may be based on the linkage status determined for each keyword present in the identified set of keywords.

Further, modelling of a questionnaire may be triggered. The modelled questionnaire may include questions relevant to the content and the one or more topics. In one example, the questionnaire may be modelled based on the relevant set of keywords to derive the questions. The questions may be highly relevant to the content and the one or more topics as the questions are derived based on the selected set of keywords having a correlation with the one or more topics and appearing frequently in the content. Each of the questions may then be classified into one or more clusters, where each of the one or more clusters may be associated with a topic from amongst the one or more topics.

In one example, a destination, from amongst a plurality of destinations, may be identified to receive a set of questions from at least one of the one or more clusters. In one example, the destination may be an agent capable of providing a response to the set of questions. The destination may be identified, in one example, based on the preference parameter. Each of the plurality of destinations may be linked with the preference parameter associated with each of the one or more topics, where each of the one or more topics is linked with at least one of the one or more clusters. Thus, an interlinked relationship may be formed between each of the plurality of destinations, the one or more topics, and the one or more clusters, having at least the preference parameter as a common interconnecting link therebetween.

A questionnaire delivery information may then be generated for delivering the set of questions to the identified destination. The questionnaire delivery information may include a destination identifier associated with the identified destination. In one example, the destination identifier may include a unique identification indicator associated with the destination, such as the agent, for identifying the agent. The unique identification indicator may be, for example, an email address associated with the identified agent. The agent may be, for example, a user or a trained model for providing response to the set of questions.

The present subject matter may address the problems associated with conventional techniques. For example, by determining the correlation between each of the identified keywords and each of the topics, relevant keywords may be identified that may be used for modelling the questions. Since correlated keywords may be selected, insightfully relevant questions may be modelled or designed to gain an understanding or gather feedback on the content provided in the document. Further, as correlation may be determined between keywords and topics, the questionnaire may be dynamically modelled based on content and topics associated with the machine-readable document.

Furthermore, by determining destination, for example an appropriate agent or the individual, the set of questions may be channeled to appropriate destinations that may be considerably capable of providing the response to the set of questions. As the questions may be channeled to appropriate destination, inaccurate channeling of the questions to inappropriate destinations or individuals may be reduced. Thus, there may be no, or at least reduced, necessity of retransmitting the set of questions to appropriate destinations. As a result, computing resources and network resources may be efficiently utilized. Also, channeling the questions to appropriate destinations, that may be capable or responsible for answering the questions, may enhance the probability of receiving appropriate response. The question(s) may thus appropriately be addressed, thereby reducing requirements of retransmission, on one hand, and improving the quality and accuracy of the document, on the other hand.

Also, as the destination may be appropriate, for example, an individual concerned with a particular topic, it may be possible that data or the content of the document may get efficiently assessed up to an appropriate extent to derive a suitable response. As a result, the data or content may be efficiently utilized, thereby enhancing the overall efficiency of data utilization. Further, the subject matter discussed above may at least assist the individuals in considerably reducing the time required for preparing one or more sections of the document, thereby enhancing the overall work efficiency and reducing engagement time with the computing and network resources. Therefore, the accuracy of the document, the overall process of preparing the document, and the utilization of resources and data or content is enhanced.

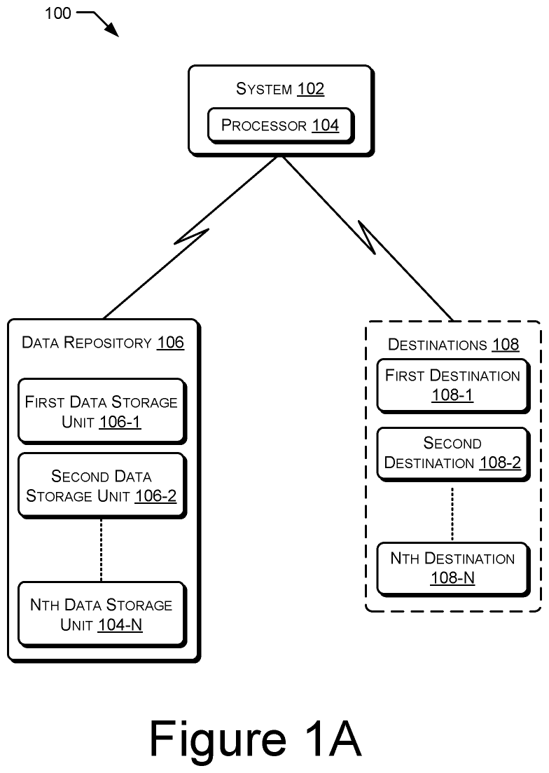

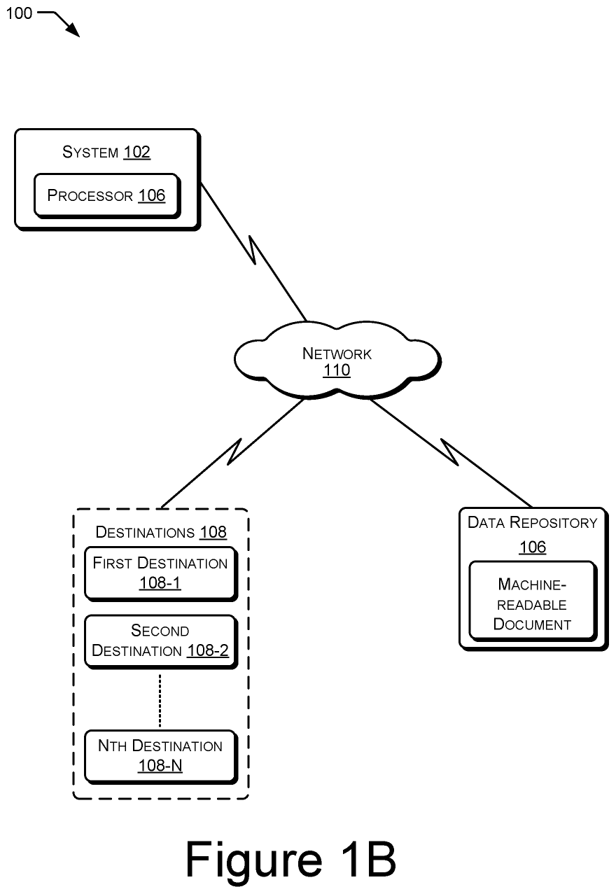

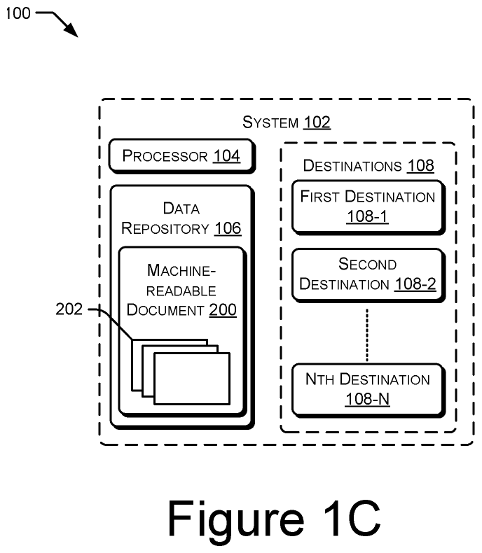

The above techniques are further described with reference to FIGS. 1A to 8. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIGS. 1A to 1C illustrate a computing environment 100 comprising a system 102, according to an example implementation. In one example, the computing environment 100 may be associated with one or more organizations where multiple computing devices may be communicably coupled with each other. In another example, the computing environment may be associated with a service or platform that may be accessed by one or more users.

The system 102 may be implemented in the computing environment 100 and may be communicably coupled with one or more of the computing devices associated with the computing environment 100. In one example, the system 102 may generate content and identify at least one destination for the generated content. The system 102, in one example, may be associated with at least one organization. The organization, or individuals associated with the organization, may utilize the system 102, in one example, for assistance in generation of content and/or identification of a destination for the generated content.

In one example, the system may include a processor 104. The processor 104 may be configured to, in one example, generate the content and identify at least one destination for the generated content. The processor 104 may be implemented as a dedicated processor, a shared processor, or a plurality of individual processors, some of which may be shared.

The computing environment 100 may further include, in one example, a data repository 106. The data repository 106 may be configured to store data including, for example, the content. The data repository 106 may be implemented by one or more physical storage devices, virtual storage instances, or a combination thereof. In one example, the data repository 106 may include one or more data storage units. For example, the data repository 106 may include a first data storage unit 106-1, a second data storage unit 106-2, . . . a Nth data storage unit 106-N, where N is a natural number. The first data storage unit 106-1, the second data storage unit 106-2, . . . the Nth data storage unit 106-N may collectively be referred to as the data repository 106. The data repository 106, in one example, may include only a single data storage unit. For example, the data repository may include the first data storage unit 106-1.

In one example, the data repository 106 may implement distributed data storage techniques. For example, the data or content may be stored in a distributed manner across the first data storage unit 106-1, the second data storage unit 106-2, . . . and the Nth data storage unit 106-N. Also, in one example, the data or content may be replicated on the first data storage unit 106-1, the second data storage unit 106-2, . . . and the Nth data storage unit 106-N. Distribution and data replication may enhance fault tolerance against loss of data, for example, due to failure or loss of connection with any of the data storage units 106-1 to 106-N.

Further, in one example, the data storage units 106-1 to 106-N may be located at different locations and may be communicably coupled with each other. The data storage units 106-1 to 106-N, in one example, may also have different properties. For example, some of the data storage units may have high-speed read/write capabilities as compared to the other data storage units of the data repository 106. The data repository 106 may dynamically enable read and write operations at varying speeds based on different conditions, for example, importance level associated with requests to read and write data from/to the data storage units 106-1 to 106-N.

In one example, the data repository 106 may be a source of the content. For example, the data repository 106 may include data that may be processed to generate content. For instance, the data repository 106 may store the content itself, and the content may be utilized for generating additional content, as will be discussed. In one example, the additional content may be a questionnaire having one or more questions derived based on the content stored in the data repository 106, as will be discussed. The content and/or the additional content may be associated with different topics, for example, features, modifications, characteristics, performance, results, quality, sales, specification, and workflows that may be associated with products and/or services. The topics may also be related to computer programs associated with one or more web pages, user or customer-related data, diagnostic reports associated with a patient, and research-related data. The content and/or the additional content may be in textual format, non-textual format, or a combination of both.

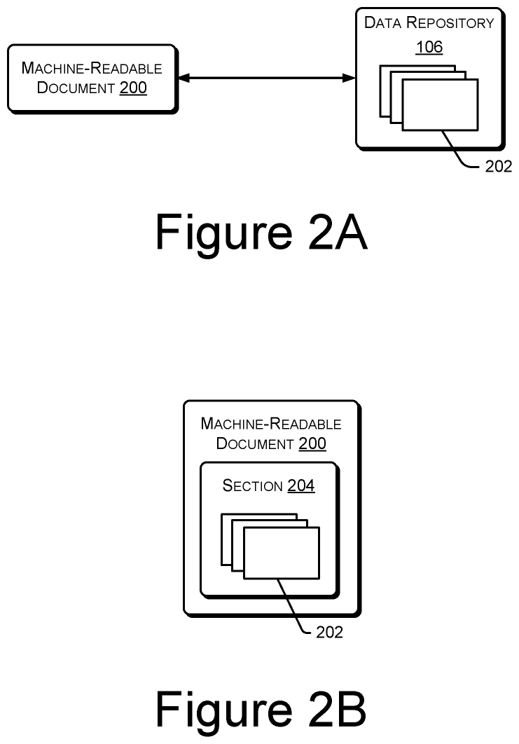

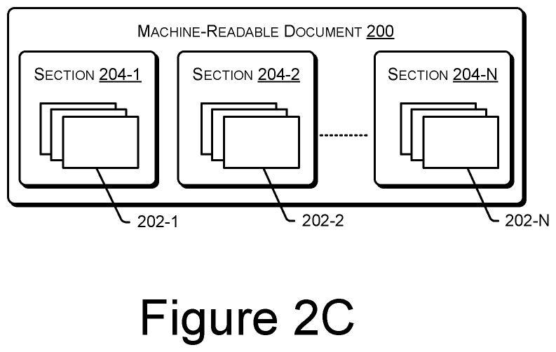

In one example, the content may be associated with a machine-readable document. In another example, the content may be embedded in the machine-readable document. FIGS. 2A to 2C illustrate a machine-readable document 200, according to an example implementation, the machine-readable document 200 may be a collection of textual or non-textual content that may be interpretable, readable, processable, and/or scannable by a machine. The machine-readable document 200 may be analytical reports indicating performance of an organization or operation(s) associated therewith. Other examples the machine-readable document 200 may include, but are not limited to, a set of web pages, computer program associated with the set of web pages, review reports, annual product quality review (APQR) reports, finance-related statements, sales reports, datasheets, Food and Drug Administration (FDA) reports, manuals, catalogs, editable computer-readable files, drawings, and the like. In one example, the machine-readable document 200 may also be a collection of multiple machine-readable documents.

In one example, the machine-readable document 200 may be stored in the data repository 106, as illustrated in FIG. 1B. For example, the machine-readable document 200 may be stored on one or more of the data storage units 106-1 to 106-N. The machine-readable document 200, interchangeably referred to as document 200, may have the content, hereinafter referred to as content 202, associated therewith.

The document 200 may include the content 202 in different formats, for example, text, images, optical codes, machine-readable codes, tables, charts, graphs, templates, advertisements, dashboards, and a combination thereof. In one example, the content 202, stored in the data repository 106, may be linked with the document 200, as illustrated in FIG. 2A. For example, the document 200 may include means, such as hyperlinks, that may direct to the content 202 associated with the document 200. In another example, the content 202 may be embedded in the document 200, as illustrated in FIG. 2B, and the document 200 may be stored in the data repository 106. Similarly, multiple documents may be stored in the data repository 200 that may have no relation between each other.

Further, in one example, the document 200 may include one or more sections 204-1, 204-2, . . . 204-N, where N may be a natural number. The one or more sections 204-1, 204-2, . . . 204-N, as illustrated in FIG. 2C, may be collectively referred to as sections 204 and individually as section 204, as illustrated in FIG. 2B. Each of the sections 204 may be associated with at least one of the topics linked to the content 202. In one example, the content 202 may be distributed amongst the sections 204. As the content 202 may include information related to different topics, the content 202 may accordingly be distributed or organized amongst the sections 204. For instance, if the content 202 includes information related to product quality and sales, the content 202 may accordingly be distributed into sections 204 related to quality and sales, respectively. Thus, based on the topic of the content 202, the content 202 may be accordingly associated with the corresponding sections 204. In another example, instead of division and/or distribution of the content 202, the content 202 may be associated with the document 200 without any explicit divisions, forming a single section 204, as illustrated in FIG. 2B.

The computing environment 100 may further include a plurality of destinations 108. In one example, the destinations 108 may be recipient of the content generated by the system 102, as will be discussed. The plurality of destinations 108 may include, for example, a first destination 108-1, a second destination 108-2, . . . , and a Nth destination 108-N, where N is a natural number. Th first destination 108-1, the second destination 108-2, . . . , and the Nth destination 108-N may collectively be referred to as destinations 108 and individually be referred to as destination 108. Examples of the destinations 108 may include, but are not limited to, a virtual destination, a user equipment, and an agent. For example, the first destination 108-1 may be the virtual destination, the second destination 108-2 may be the user equipment, and the Nth destination 108-N may be the agent.

An example of the virtual destination may include, but is not limited to, communication-related destination associated with an expert individual. The communication-related destination may include, for example, email address of the expert individual, a telephone number of the expert individual, and the like. Further, examples of the user equipment may include, but are not limited to, mobile phone, laptop, desktop computer, a smart watch, a smart wearable headset, a tablet, and a personal digital assistant (PDA). Examples of the agent may include, but are not limited to, machine learning models, artificial intelligence-based models, deep learning-based models.

In one example, the system 102, the data repository 106, and the destinations 108 may be in direct communication, as illustrated in FIG. 1A, and may exchange data and signals. In another example, the system 102, the data repository 106, and the destinations 108 may be in communication with each other through a network 110, as illustrated in FIG. 1B, and may exchange data and signals over the network 108. For instance, the system 102, the data repository 106, and the destinations 108 may be distributed across different locations and/or platforms and may be communicably coupled by the network 110 to assist in inter-communications. Examples of such network 110 may include, but are not limited to, local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the network 110 may include various network entities, such as transceivers, gateways, and routers. In an example, the network 110 may include any communication network that uses any of the commonly used protocols, for example, Hypertext Transfer Protocol (HTTP), and Transmission Control Protocol/Internet Protocol (TCP/IP).

In yet another example, the system 102 may include the processor 104, the data repository 106 having the machine-readable document 200 stored therein, and the destinations 108, as illustrated in FIG. 1C. The processor 104, the data repository 106, and the destinations 108 may be communicably coupled with each other, for example, to exchange data and signals.

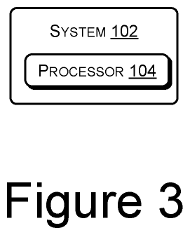

FIG. 3 illustrates a block diagram of the system 102, according to an example implementation. FIG. 3 will be discussed in conjunction with FIGS. 1A to 2C.

In one example, the system 102 may generate content and identify a destination for the generated content. The system 100 may include a processor, such as the processor 104, configured to generate the content and identify the destination, such as a destination from amongst the destinations 108. For example, the processor 104 may process, or assist in processing, the content 202 stored in the data repository 106 and generate additional content for one or more of the sections 204 of the document 200. In one example, one of the sections 204, say section 204-N, may be the questionnaire section for which the processor 104 may generate, or assist in generating, the content. The content may be, in one example, the one or more questions associated with the content 202 stored in the data repository 106. Thus, the processor 104 may be configured to generate, or assist in generating, the questionnaire having one or more questions (i.e., the additional content, referred to as the content 202-N) and, subsequently, identify at least one of the destinations 108 for each of the one or more questions.

As previously discussed, the document 200 may include the content 202 distributed among the one or more sections 204, where each of the one or more sections 204 may be associated with one or more topics linked to the content 202. The content 202 and/or the document 200 may be stored in the data repository 106. Further, each of the one or more topics may have a preference parameter linked therewith. The preference parameter may indicate, for example, a significance or importance of each of the one or more topics.

In operation, the processor 104 may parse the content 202 associated with the machine-readable document 200 to identify a set of keywords. For example, the processor 104 may access the content 202, such as the content 202-1 and 202-2, associated with document 200. The processor 104 may then analyse the content 202 to identify one or more keywords that may be, for example, the most frequently appearing keywords in the content 202. The set of keywords may include such identified one or more keywords.

The processor 104 may then compute an interrelationship metric for each keyword present in the identified set of keywords. In one example, the interrelationship metric may be computed based on a correlation between each keyword and each of the one or more topics linked to the content 202. The processor 104 may determine the interrelationship metric, in one example, to ascertain which of the keywords may be correlated to which of the one or more topics linked to the content 202.

The interrelationship metric, in one example, may be a score indicating an extent or level of correlation. For example, a keyword being correlated to a topic may have a higher score as compared to another keyword that may not be correlated with the topic. The correlation may be, for example, a simple correlation or a complex correlation. In the simple correlation, each keyword present in the identified set of keywords may have a straight-forward relationship with at least one of the one or more topics. In the complex correlation, each keyword present in the identified set of keywords may not have a straight-forward relationship with at least one of the one or more topics. For example, each keyword may be correlated with at least one intermediary keyword present in the identified set of keywords. The at least one intermediary keyword may thus create a linked relationship with at least one of the one or more topics.

Further, the processor 104 may determine a linkage status for each keyword present in the identified set of keywords. In one example, the linkage status may indicate a potential relevance between each keyword, present in the identified set of keywords, and each of the one or more topics. To determine the linkage status, the processor 104 may, in one example, initiate a comparative assessment between the interrelationship metric, computed for each keyword present in the identified set of keywords, and a threshold linkage score. For example, the processor 104 may compare the interrelationship metric, computed for each keyword, with the threshold linkage score. If the interrelationship metric for a keyword is equal to or greater than the threshold score, the processor 104 may ascertain that the keyword may be linkable or relevant to at least one of the one or more topics. However, if the interrelationship metric for a keyword is less than the threshold score, the processor 104 may ascertain that the keyword may be considered to be potentially irrelevant to the one or more topics.

Based on the linkage status determined for each keyword present in the identified set of keywords, the processor 104 may filter a relevant set of keywords from the identified set of keywords. In one example, the processor 104 may select the keywords for which the linkage status may have been ascertained to be linkable or relevant. The processor 104 may thus select the keywords that may be relevant to the one or more topics associated with the content 202.

Further, the processor 104 may, in one example, trigger modelling of a questionnaire based on the relevant set of keywords. In one example, the processor 104 may be configured to generate questions using the relevant set of keywords. For example, the processor 104 may be configured to frame the questions based on the relevant set of keywords. The modelled questionnaire may include the questions. In another example, the processor 104 may trigger modelling of the questionnaire by generating a signal for an external content generator communicably coupled with the processor 104. The external content generator may have the capability to receive the relevant set of keywords and generate the questions based on the relevant set of keywords. In one example, the external content generator may be a trained artificial intelligence-based model or platform that may model the questionnaire.

Since the questions may be modelled based on the relevant set of keywords, that may be frequently appearing in the content 202 and that may be correlated with the one or more topics, the probability of modelling the questions highly relevant to the content 202 and the one or more topics may increase. Questions relevant to the content 202 may be, for example, questions for which answers can be drawn by referring to the content 202. The relevant question may enhance the probability of providing a more meaningful, accurate, and focused insight into the content 202 associated with the document 200. Also, as modelling of the questions may be dependent upon the relevant set of keywords and the one or more topics linked to content 202, the content 202 may get utilized in a thorough manner. Thus, the extent up to which the data or the content 202 may be used for modelling the questions may increase. As a result, the efficiency with which the data or content 202 may be utilized may improve.

Further, modelling of the questions may be dynamic in nature. For example, with change in the relevant set of keywords and the topics, the questions may get dynamically modelled. Therefore, different questions may be modelled with change in any one of the relevant set of keywords and the one or more topics. For example, if the content 202 associated with the document 200 is modified, the processor 104 may be configured to update the questions according to the modified content. In another example, a document, different than the document 200, having content linked to the same one or more topics as the document 200, but having different relevant set of keywords, may result in modelling of different questions. Thus, modelling of the questions may not be static.

Subsequently, the processor 104 may initiate classification of each of the questions into one or more clusters. Each of the one or more clusters may be associated with a topic from amongst the one or more topics linked to the content 202. In one example, the processor 104 may be configured to initiate topic modelling to analyse each of the questions and classify each of the questions into the one or more clusters. For example, the processor 104 may initiate parsing of the questions to determine the topic with which each of the questions may be associated. The questions that are determined to be associated to same topics may be grouped or clustered into same cluster. Thus, questions may be clustered based on the topic with which they may be associated.

Further, the processor 104 may identify a destination, from amongst the plurality of destinations 108, to receive a set of questions from at least one of the one or more clusters. The destination 108 may be identified, in one example, based on the preference parameter. Each of the plurality of destinations 108 may be linked with the preference parameter associated with each of the one or more topics, where each of the one or more topics is linked with at least one of the one or more clusters. Thus, an interlinked relationship may be formed between each of the plurality of destinations, the one or more topics, and the one or more clusters, having at least the preference parameter as an interconnecting link therebetween.

In one example, the processor 104 may identify the first destination 108-1 as the destination to receive the set of questions, based on the preference parameter. The first destination 108-1 may be, in one example, the virtual destination associated with an expert individual having skills, experience, authority, and/or capabilities of responding to the set of questions. The virtual destination may be, for example, an email address associated with the expert individual.

The processor 104 may then generate a questionnaire delivery information for delivering the set of questions to the identified destination, for example, the first destination 108-1. In one example, the questionnaire delivery information may include a destination identifier associated with the identified destination. The destination identifier may include a unique identification indicator associated with the destination, for identifying the destination. The unique identification indicator may be, for example, the email address associated with the identified expert individual. Thus, the processor may identify a suitable destination and generate the questionnaire delivery information for delivering the set of questions to the destination.

The processor may assist in channeling the generated content, for example, the set of questions to an appropriate destination that may be considerably capable of responding to the set of questions. As the questions may be channeled to appropriate destination, inaccurate channeling of the questions to inappropriate destinations may be minimized. Thus, there may be reduced necessity of retransmitting the generated content to appropriate destinations.

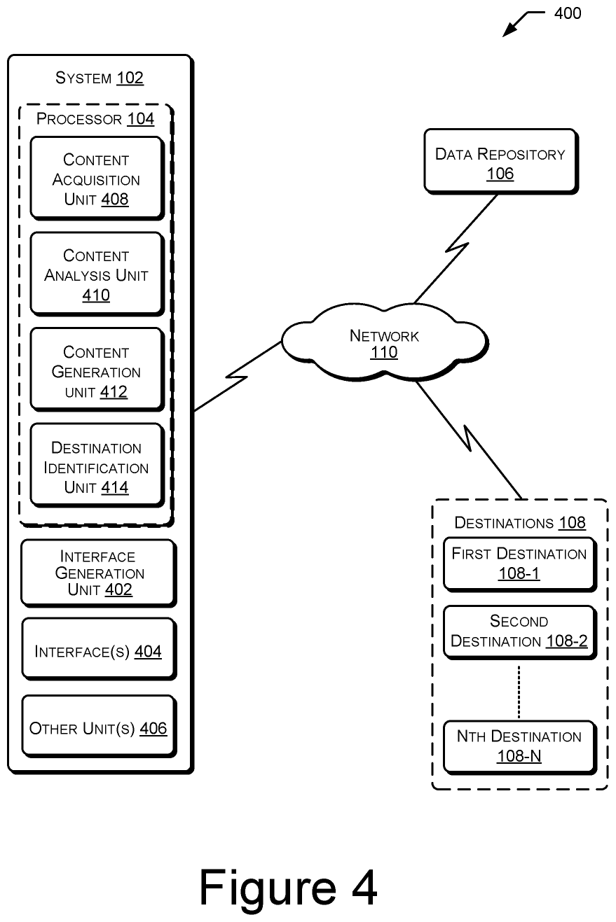

FIG. 4 illustrates a computing environment 400 comprising the system 102, according to another example implementation. In one example, the computing environment 400 may be similar to the computing environment 100. The computing environment 400 may be a network of communicably coupled computing devices. In one example, the computing environment 100 may be associated with one or more organizations where multiple computing devices may be communicably coupled with each other over the network 110. In another example, the computing environment 400 may be associated with a service or platform that may be accessed by one or more users over the network 110. In one example, the computing environment 400 may include the system 102, the data repository 106, and the destinations 108. The system 102, the data repository 106, and the destinations 108 may be communicably coupled with each other over the network 110.

In one example, the system 102 may generate, or at least assist in generation of, content and identify a destination, from amongst the plurality of destinations 108, for the generated content. In one example, the generated content may be the questionnaire, hereinafter interchangeably referred to as the content 202-N.

The system 102, in one example, may be associated with at least one organization. The organization, or individuals associated with the organization, may utilize the system 102, in one example, for assistance in generation of content and/or identification of a destination for the generated content. The system 102 may either be managed by the organization or an external entity, for example, a third-party organization designated for managing the system 102. For example, the system 102 may be implemented as a combination of hardware and software components that may be managed and hosted either by the organization itself or by the third-party organization.

In another example, the system 102 may be offered as a platform or service and may be assessed by one or more organizations or users willing to generate content. For example, the system 102 may be offered as a Platform as a Service (PaaS) or Software as a Service (SaaS) for assisting in content generation and identification of at least one suitable destination for at least the generated content. For example, the system 102 may be hosted on a cloud-based platform and may be accessed by the organizations, or individuals associated with the organizations. In another example, the system 102 may associated with a platform that may assist in generation of the content and/or dynamic identification of the destination for the generated content. The platform may be used by one or more users, collectively by a group of users, and organizations or individuals associated therewith.

Further, in one example, the system 102 may be implemented as a user assistance platform, or at least a part thereof, that may be utilized by common audience or users for intuitively generating content and/or identification of a destination for the generated content. The common users may include a general audience, for example, any user having the intent to generate content and/or provide the content to a destination.

In one example, the system 102 may include the processor 104, an interface generation unit 402, interface(s) 404, and other unit(s) 406. The processor 104 may be implemented as a dedicated processor, a shared processor, or a plurality of individual processors, some of which may be shared. Examples of the processor 104 may include, but are not limited to, microprocessors, microcomputers, microcontrollers, digital signal processors, central processing units, state machines, Artificial Intelligence (AI) based processors, machine learning based processors, deep learning based processors, a system on chip (SOC), processing circuitries including one or more modules or engines, and/or any other devices that manipulate signals and data based on computer-readable instructions, and/or any other devices.

Further, the interface generation unit 402 may be configured to trigger generation of an interactive interface. Examples of the interactive interface may include, but are not limited to, one or more webpages, a software application, a graphical user interface (GUI), execution of one or more scripts, one or more Application Programming Interface (API) calls, and the like. In one example, the interactive interface may have the capability to receive inputs or responses, for example, based on interactions with the interactive interface. The interactive interface may also have the capability to trigger rendering of the content 202, or at least the generated content 202-N. Upon triggering of rendering, the content 202, or at least the generated content 202-N, may be initiated on the interactive interface accessible by at least one of the destinations 108. In one example, the interface generation unit 402 may be communicably coupled with at least one of the plurality of destinations 108 to initiate rendering of the content 202, or at least the content 202-N, and causing reception of a response or inputs to at least the content 202-N. In one example, the response and the content 202 may be rendered on one or more display devices associated with the destinations 108.

The interface(s) 404 may allow the communicably coupling the system 102 with one or more other entities, such as the data repository 106, the destinations 108, and the network 110. The connection or coupling may be through a wired (e.g., Local Area Network, i.e., LAN) connection or through a wireless connection (e.g., Bluetooth®, Wi-Fi). The interface(s) 404 may also enable intercommunication between different logical as well as hardware components of the system 102.

The other unit(s) 406 may include, in one example, a power supply unit, a communication unit, and a memory. The power supply unit may, for example, manage distribution or supply of electrical current within the system 102 for functioning of the system 102. Further, the communication unit may be, in one example, a wireless communication unit. Examples of the communication unit may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication unit may also include one or more antennas to enable wireless transmission and reception of data and signals. The communication unit may allow the system 102 to transmit data and signals to one or more other devices, such as the data repository 106 and the destinations 108, and receive data and signals, for example, from the data repository 106 and the destinations 108.

Furthermore, the memory may be a computer-readable medium, examples of which include volatile memory (e.g., RAM), and/or non-volatile memory (e.g., Erasable Programmable read-only memory, i.e., EPROM, flash memory, etc.). The memory may be an external memory, or internal memory, such as a flash drive, a compact disk drive, an external hard disk drive, or the like. The memory may further include, for example, at least a portion of the generated content.

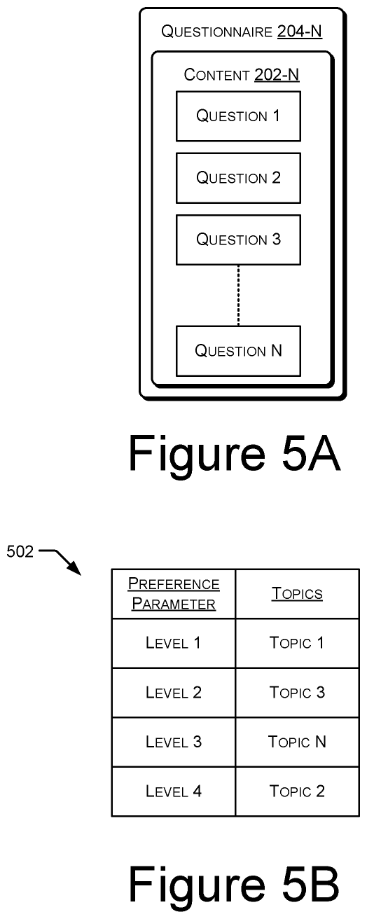

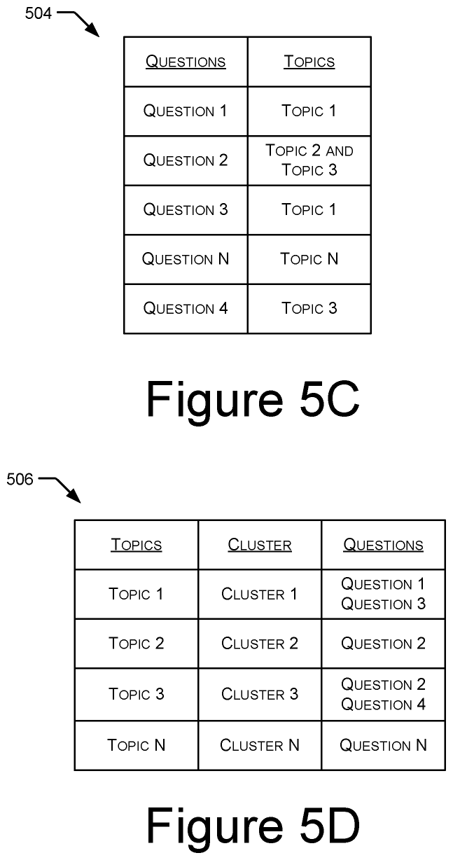

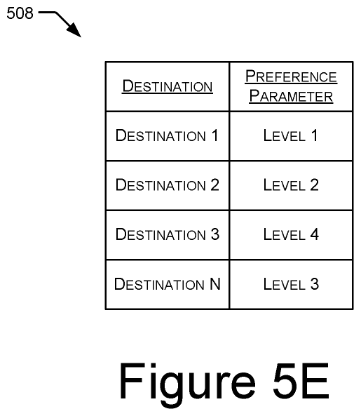

In one example, the processor 104 may be configured to generate, or at least assist in generation of, the content. For example, the processor 104 may generate, or at least assist in generation of, the questionnaire having one or more questions. FIG. 4 will be discussed in conjunction with FIGS. 1A to 2c and FIGS. 5A to 5E. FIG. 5A illustrates a questionnaire having questions, according to one example implementation. In one example, the questionnaire may be generated as a section, for example, as the section 204-N associated with the document 200. The section 204-N may hereinafter be referred to as questionnaire 204-N. The questionnaire 204-N may have the generated content, for example, the questions. For example, the questionnaire 204-N may have question 1, question 2, question 3, . . . question N, where N is a natural number. The questions may hereinafter collectively be referred to as questions 202-N and individually be referred to as question 202-N.

In operation, the processor 104 may access the content 202 associated with the document 200. In one example, the processor 104 may communicate with the data repository 106 to access the content 202 associated with the document 200. The processor 104 may include, in one example, a content acquisition unit 408 to communicate, request, and obtain the content 202 from the data repository 106. In one example, the content 202 may be associated with one or more organizations and may be pre-stored in the data repository 106. In one example, the content 202 may be associated with the document 200 and the document may be stored in the data repository 106. In this case, the content acquisition unit 408 may access the data repository 106 to obtain the document 200.

The document 200 may have, in one example, one or more sections, such as the sections 204-1 to 204-(N−1) having the content 202 in a distributed manner. Each of the sections 204-1 to 204-(N−1) may be associated with at least one of the topics linked to the content 202. In one example, the content 202 may be distributed amongst the sections 204-1 to 204-(N−1). As the content 202 may include information related to different topics, the content 202 may accordingly be distributed or pre-organized amongst the sections 204-1 to 204-(N−1). For instance, if the content 202 includes information related to production quantity of a product and sales of the product, the document 200 may have the content 202 accordingly arranged into sections 204 related to quantity and sales, respectively. Thus, based on the topic of the content 202, the content 202 may be accordingly associated with the corresponding sections 204-1 to 204-(N−1). In another example, instead of division and/or distribution of the content 202, the content 202 may be associated with the document 200 without any explicit divisions, forming a single section 204, as illustrated in FIG. 2B.

Further, examples of the topics may include, but are not limited to, features, modifications, characteristics, performance, results, quality, quantity, sales, specification, and workflows that may be associated with products and/or services. The topics may also be related to computer programs associated with one or more web pages, user or customer-related data, diagnostic reports associated with a patient, and research-related data.

Each of the one or more topics may have a preference parameter associated therewith. The preference parameter may indicate a significance of each of the one or more topics. FIG. 5B illustrates a table 502 indicating an exemplary association of preference parameters with the one or more topics, according to one example implementation. As illustrated in the table 502, each of the topics may have a pre-defined preference parameter. For example, Topic 1 may have a significance level 1 as the preference parameter, Topic 3 may have a significance level 2 as the preference parameter, Topic N may have a significance level 3 as the preference parameter, and Topic 2 may have a significance level 4 as the preference parameter. The significance level may indicate, for example, importance or criticality of the topic. For example, level 1 may have a higher importance than level 2. In one example, the preference parameter may be defined for each of the one or more topics by the expert individual or a group of expert individuals.

Further, in one example, the processor 104 may also be configured to determine the one or more topics based on the content 202. In one example, the processor may include a content analysis unit 410 to perform topic analysis for the content 202. The content analysis unit 410, in one example, may count words and find and group similar word patterns to determine a topic with which the content 202 may be linked to. The content analysis unit 410 may also be configured to detect topics by counting word frequency and the distance between each word use in the content 202. For example, if the content 202 associated with one of the sections 204 (say, section 204-1) is determined to include words indicating patterns such as currency signs followed by numbers, related words (such as costly, expensive, and cheap), synonyms (such as amount, cost, price, and retail price) or phrases (value for money), the section 204-1 may be determined to be associated with topic, for example, “price”.

In another example, the content analysis unit 410 may be configured, or communicably coupled, with topic analysis models that may be able to detect topics from the content 202 with pre-trained advanced machine learning algorithms. In yet another example, the content analysis unit 410 may be configured to perform topic Identification using any other known method. For example, the content analysis unit 410 may be configured with the Latent Dirichlet Allocation (LDA) technique for identifying the one or more topics associated with each of the sections 204-1 of the document 200.

Further, the processor 104 may parse the content 202 associated with the document 200 to identify a set of keywords. In one example, the content analysis unit 410 may be configured to parse the content 202. For parsing the content 202, the content analysis unit 410 may break down components (such as textual or non-textual information) of the content 202 into parts of speech with an explanation of form, function, and syntactic relationship. By parsing the content 202, the content analysis unit 410 may group words that may be repeatedly combined to form a sentence in the content 202 and identify the most frequently appearing words. In another example, the content analysis unit 410 may break the content 202 and create word clouds or tag clouds for keyword extraction. The word clouds of tag clouds may indicate a visualization of elements, such as words, that may be frequently appearing in a cluster of words. The content analysis unit 410 may thus identify the set of keywords, for example, words that may be frequently appearing in the content 202.

In another example, the content analysis unit 410 may create a matrix, where each of the words present in the content 202 may be given a score. The score may be calculated as the degree of a word in the matrix (i.e., an aggregate of the number of co-occurrences the word has with any other word in the content 202), as the word frequency (i.e., an aggregate of the number of times the word appears in the content 202). In yet another example, the content analysis unit 410 may use any statistical approach, including word frequency, word collections, word co-occurrence, term frequency-inverse document frequency (TF-IDF), and Rapid Automatic Keyword Extraction (RAKE). However, the content analysis unit 410 may also be configured to use any other known approaches to extract or identify the set of keywords, such as frequently appearing words. For example, the content analysis unit 410 may be configured to use linguistic approaches, graph-based approaches, machine learning-based approaches, or a combination thereof. The content analysis unit 410 may, in one example, communicate with a component external to the system 102 to identify the set of keywords. The component may be, for example, a parser software/application that may be requested, by the content analysis unit 410, to identify the set of relevant keywords.

The processor 104 may then compute an interrelationship metric for each keyword present in the identified set of keywords. In one example, the interrelationship metric may be computed based on a correlation between each keyword and each of the one or more topics linked to the content 202. The processor 104 may determine the interrelationship metric, in one example, to ascertain which of the keywords may be correlated to which of the one or more topics linked to the content 202. In one example, the content analysis unit 410 may determine a correlation between each keyword, present in the identified set of keywords, and each of the one or more topics. To determine correlation between two variables (i.e., a keyword and a topic), the content analysis unit 410 may analyse their co-occurrence in the given content 202 (such as the content 202-1 and 202-2). The content analysis unit 410 may be configured to implement techniques, for example, cosine similarity, Jaccard similarity, or Pearson correlation to quantify the relationship between the keywords and the topics. In another example, the libraries. Examples of the libraries may include, but are not limited to, Natural Language Toolkit (NLTK), spaCy, and other natural language processing-based libraries or models.

The interrelationship metric, in one example, may be a score indicating an extent or level of correlation. For example, a keyword being correlated to a topic may have a higher score as compared to another keyword that may not be correlated with the topic. In one example, to determine the score, the content analysis unit 410 may be configured for assessing relevance or association of each keyword within the context of each of the one or more topics. The content analysis unit 410 may utilize, in one example, a topic modelling algorithm to identify the one or more topics linked to the content 202. Each keyword in the identified set of keywords may be assigned to one or more topics based on output of the topic modelling. Topic modelling libraries may often provide a relevance score for each keyword in relation to a particular topic. The relevance score of the keyword within each of the topics may then be examined. The relevance scores of the keyword across all the topics may be aggregated or averaged. This aggregated score may be used as the interrelationship metric (i.e., as a correlation measure) between each of the keywords and the one or more topics linked to the content 202.

In another example, the content analysis unit 410 may be configured to use any known technique to determine the interrelationship metric (i.e., a score indication a measure of correlation) between each keyword, in the identified set of keywords, and each of the one or more topics. For example, the content analysis unit 410 may be configured to utilize the topic modelling to determine Latent Dirichlet Allocation (LDA) relevance score and/or Non-Negative Matrix Factorization (NMF) relevance core. The relevance score of the keyword within each of the topics may then be examined. The relevance scores of the keyword across all the topics may be aggregated or averaged. This aggregated score may be used as the correlation measure between each of the keywords and the one or more topics. In yet another example, the content analysis unit 410 may be configured to use any known software libraries to determine the correlation score between each keyword, in the identified set of keywords, and each of the one or more topics.

Further, the correlation may be, for example, a simple correlation or a complex correlation. In the simple correlation, each keyword present in the identified set of keywords may have a straightforward relationship with at least one of the one or more topics. In the complex correlation, each keyword present in the identified set of keywords may not have a straightforward relationship with at least one of the one or more topics. For example, each keyword may be correlated with at least one intermediary keyword present in the identified set of keywords. The at least one intermediary keyword may thus create a linked relationship with at least one of the one or more topics. Several keywords may be conceptually or semantically relevant to the one or more topics, however, may not have a straightforward relationship. The content analysis unit 410 may be configured to analyse relationships among a large number of conceptually similar variables, for example, the keywords. For example, the content analysis unit 410 may be configured to utilize complex statistical techniques, such as the factor analysis, to determine the complex correlations. Thus, the processor 104 may be capable of identifying correlations at multiple levels, thereby providing an extensive mechanism for capturing correlated keywords, even when the keywords may not have a direct correlation with the topics.

Once the interrelationship metric is computed, the processor 104 may determine a linkage status for each keyword present in the identified set of keywords. In one example, the linkage status may indicate a potential relevance between each keyword, present in the identified set of keywords, and each of the one or more topics. To determine the linkage status, the content analysis unit 410 may initiate a comparative assessment between the interrelationship metric, computed for each keyword present in the identified set of keywords, and a threshold linkage score. For example, the processor 104 may compare the interrelationship metric, computed for each keyword, with the threshold linkage score. In one example, the threshold linkage score may be a predefined score. For example, the expert individual may define the threshold linkage score. Further, in one example, a threshold linkage score may be defined for each of the one or more topics. The threshold linkage score may indicate a minimum score required by a keyword to be considered as potentially relevant to a topic. If the interrelationship metric for a keyword is equal to or greater than the threshold score, the processor 104 may ascertain that the keyword may be linkable or relevant to at least one of the one or more topics. However, if the interrelationship metric for a keyword is less than the threshold score, the processor 104 may ascertain that the keyword may be considered to be potentially irrelevant to the one or more topics.

In one example, the threshold linkage score may be modifiable based on relevance requirements. For example, the expert individual may dynamically modify the pre-defined threshold linkage score for redefining the minimum score required by a keyword to be considered as potentially relevant to a topic. Increasing the threshold linkage score may result in selection of keywords that may be strongly relevant to the one or more topics, thereby improving the selection criteria.

Based on the linkage status determined for each keyword present in the identified set of keywords, the processor 104 may filter a relevant set of keywords from the identified set of keywords. In one example, the content analysis unit 410 may select the keywords for which the linkage status may have been ascertained to be linkable or relevant.

Further, the processor 104 may, in one example, trigger modelling of a questionnaire based on the relevant set of keywords. In one example, the processor 104 may include a content generation unit 412 configured to generate questions using the relevant set of keywords. For example, the content generation unit 412 may be configured to frame the questions based on the relevant set of keywords. In one example, the content generation unit 412 may utilize algorithms and pre-trained language models to understand the semantics of the relevant set of keywords, allowing them to generate questions based on the given content 202. For example, the content generation unit 412 may analyse the relevant set of keywords using natural language processing (NLP) techniques to identify key information, patterns, and context to formulate relevant questions.

In another example, the content generation unit 412 may analyse syntactic and semantic relationships between each keyword present in the relevant set of keywords to determine the structure and meaning of the keywords. The content generation unit 412 may further utilize machine learning models, for example, deep learning architectures that may be pre-trained on vast datasets (such as datasets having multiple questions and answers) to be able to grasp language nuances and context. During the question modelling process, the model may identify important information, infer relationships, and accordingly formulates the questions. The content generation unit 412 may also be configured to incorporate additional strategies, such as rule-based systems or reinforcement learning, to enhance the quality of generated questions. An exemplary questionnaire 204-N having question has been illustrated in FIG. 5A.

In another example, the content generation unit 412 may be remotely coupled to the system 102 (not illustrated) and the content analysis unit 410 may communicate with the content generation unit 412 for triggering modelling of the questionnaire 204-N. For example, the content analysis unit 410 may generate a signal that may be communicated to the content generation unit 412. The content analysis unit 410 may also communicate the determined relevant set of keywords to the content generation unit 412 for assisting in modelling of the questionnaire. The content generation unit 412 may have the capability to receive the relevant set of keywords and generate the questions based on the relevant set of keywords, as discussed above. In one example, the content generation unit 412 may be a trained artificial intelligence-based model or platform that may model the questionnaire and may be communicably coupled to the system 102. For example, the interface(s) 404 may enable the system 102 to be communicably coupled with the content generation unit 412 over the network 110.

Further, the processor 104 may be configured to trigger addition of the modelled questionnaire into at least one of the sections, say the section 204-N, from amongst the one or more sections associated with document 200. In one example, the content generation unit 412 may be triggered to add the modelled questionnaire in the section 204-N.

Once the questionnaire has been modelled, the processor 104 may initiate classification of each of the questions into one or more clusters. Each of the one or more clusters may be associated with a topic from amongst the one or more topics linked to the content 202. In one example, the content analysis unit 410 may receive the questions and may initiate topic modelling (as also discussed above) to analyse and classify each of the questions into one or more clusters, based on a determination of the topic with which the questions are associated. For example, the content analysis unit 410 may initiate parsing of text present in the questions to ascertain relevance of each of the questions with at least one of the one or more topics. The content analysis unit 410 may split a question into individual words and convert the question into vector or numerical format by utilizing, for example, TF-IDF or word embeddings. The content analysis unit 410 may then select at least one of the LDA or NMF topic modelling algorithms. The selected algorithms may then be implemented on the vectorized questions to determine a topic with which each of the questions may be associated with.

In another example, the content analysis unit 410 may utilize one or more natural language processing models to determine a topic with which each of the questions may be associated. In yet another example, the libraries to determine a topic with which each of the questions may be associated. Examples of the libraries may include, but are not limited to, NLTK, spaCy, and other natural language processing-based libraries or models.

FIG. 5C illustrates a table 504 indicating an exemplary association between the questions and the topics, according to an example implementation. As illustrated in the table 506, the content analysis unit 410 may determine question 1 to be associated with topic 1, question 2 to be associated with topics 2 and 3, question 3 to be associated with topic 1, question N to be associated with topic N, and question 4 to be associated with topic 3.

Further, each of the clusters may be linked with a topic from amongst the plurality of topics, as discussed above. FIG. 5D illustrates a table 506 indicating exemplary links between the clusters, the topics, and the questions, according to an example implementation. As illustrated in the table 506, cluster 1 may be linked to topic 1. As questions 1 and 3 are determined to be associated with topic 1 (as also illustrated In FIG. 5C), a link or association may be formed between topic 1, cluster 1, and the questions 1 and 3. Thus, the questions 1 and 3 may be classified into cluster 1. The questions that are determined to be associated to same topics may thus be grouped or clustered into same cluster. Similarly, question 2 may be classified into cluster 2, questions 2 and 4 may be classified into cluster 3, and question N may be classified into cluster N. Thus, the content analysis unit 410 may form one or more clusters based on the topic with which the questions may be linked.

Further, the processor 104 may identify a destination, from amongst the plurality of destinations 108, to receive a set of questions from the one or more clusters. The destination 108 may be identified, in one example, based on the preference parameter. Each of the plurality of destinations 108 may be linked with the preference parameter. FIG. 5E illustrates a table 508 indicating an exemplary link between the plurality of destinations 108 and the preference parameters, according to one example implementation. As illustrated in table 508, destination 1 (for example, the destination 108-1) may be linked to level 1, destination 2 (for example, the destination 108-2) may be linked to level 2, destination 3 may be linked to level 4, and destination N (for example, the destination 108-N) may be linked to level 3.

Since each of the preference parameters is associated with the one or more topics (as illustrated in FIG. 5B), and the one or more topics may linked with the one or more clusters (as illustrated in FIG. 5D), each of the plurality of destinations 108 may be linked to the one or more clusters. The processor 104 may thus be able to identify a destination, from amongst the destinations 108, to receive a set of questions from the one or more clusters. In one example, the processor 104 may include a destination identification unit 414 to identify a destination, from amongst the destinations 108, to receive a set of questions from the one or more clusters.

For example, considering the tables 502, 506, and 508, the destination identification unit 414 may identify the destination 1 to receive the set of questions (for example, questions 1 and 3) classified into the cluster 1. In one example, the destination identification unit 414 may identify the first destination 108-1 as the destination to receive the set of questions. The first destination 108-1 may be, in one example, the virtual destination associated with an expert individual having skills, experience, authority, and/or capabilities of responding to the set of questions. The virtual destination may be, for example, an email address associated with the expert individual.

In one example, the destination identification unit 414 may utilize a trained machine learning model to identify a destination. The machine learning model may be trained using a training data test comprising historical destination information. In one example, the historical destination information may include a mapping table indicating a relationship between the one or more clusters linked to the one or more topics, the preference parameter associated with each of the one or more topics, and the plurality of destinations associated with the preference parameter. Thus, the historical destination information may indicate a relationship between the destinations, the clusters, the topics, and the preference parameter. In one example, such relationship may have been employed in the past for directing the questions to the desired destination. For example, in past, question associated with a cluster, the cluster being linked to a topic and a defined preference parameter, may have been provided to a specific destination. One reason for providing the questions associated with the topic may be reception of accurate response for the questions. By feeding such information, the machine learning model may be trained for subsequent runs to identify appropriate destinations for the questions. In one example, any other algorithm could also be used, in a similar manner, for determining the appropriate destination. For example, an artificial intelligence-based model may be trained for identifying the appropriate destination. In yet another example, the destination identification unit 414 may be configured to utilize the mapping table, without any requirement of the machine leaning model, to identify the destination for the questions.

Once the destination has been identified, the processor 104 may generate a questionnaire delivery information for delivering the set of questions to the identified destination, say destination 108-1. The destination identification unit 414 may generate the questionnaire delivery information for delivering the set of questions to the identified destination, for example, the first destination 108-1. In one example, the questionnaire delivery information may be a signal including a destination identifier associated with the identified destination. The destination identifier may include a unique identification indicator associated with the destination 108-1, for identifying the destination. The unique identification indicator may be, for example, the email address associated with the identified destination 108-1. In one example, the destination 108-1 may be the expert individual. In another example, the identified destination, such as the destination 108-N, may be an algorithm capable of providing a response to the provided questions. The algorithm may be any trained algorithm having reasoning capabilities to provide an appropriate response for the received set of questions.

Based on the questionnaire delivery information, the destination identification unit 414 may deliver the set of questions to the identified destination. In one example, the set of questions may be routed, through the network 110, to the identified destination. For example, the set of questions may be delivered on the email address or the user equipment associated with the identified destination (for example, the expert individual) included in the questionnaire delivery information. In one example, the questionnaire delivery information may also indicate a duration indication for indicating a time period for receiving a response from the destination. The duration indication may indicate the time period within which the response to the delivered set of questions may be expected from the identified destination. The time period may be indicated, for example, in minutes, hours, days, and the like. In one example, the interface generation unit 402 may initiate rendering of the set of questions, say on the second destination 108-2. For example, the interface generation unit 402 may cause rendering of a GUI on the second destination 108-2 for rendering the set of questions.

Further, the processor 104 may be configured to cause receiving of the response, for the set of questions, from the identified destination, say the second destination 108-2. For example, the rendered GUI may include one or more fields configured to receive a response to the set of questions. In one example, destination identification unit 414 may receive the response over the network 110 via the interface(s) 404. The destination identification unit 414 may then forward the received response to the content generation unit 412 for triggering addition of the response in one of the sections, say the questionnaire section 204-N. Thus, content, including the questionnaire section 204-N and the response, may be generated for the document 200.

Further, in one example, the content acquisition unit 408, the content analysis unit 410, the content generation unit 412, and the destination identification unit 414 may be implemented as modules or engines to perform their dedicated functions. In another example, the content acquisition unit 408, the content analysis unit 410, the content generation unit 412, and the destination identification unit 414 may be implemented as processing circuitries including one or more, and/or any other devices that manipulate signals and data based on computer-readable instructions, and/or any other devices and software. In yet another example, the content acquisition unit 408, the content analysis unit 410, the content generation unit 412, and the destination identification unit 414 may be implemented as a combination of processing circuitries and modules or engines.

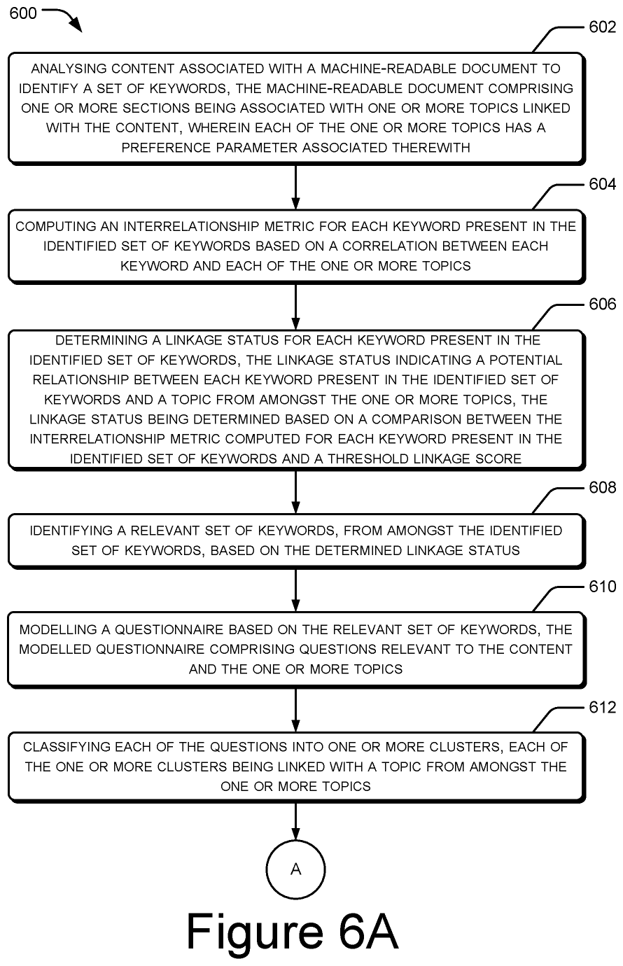

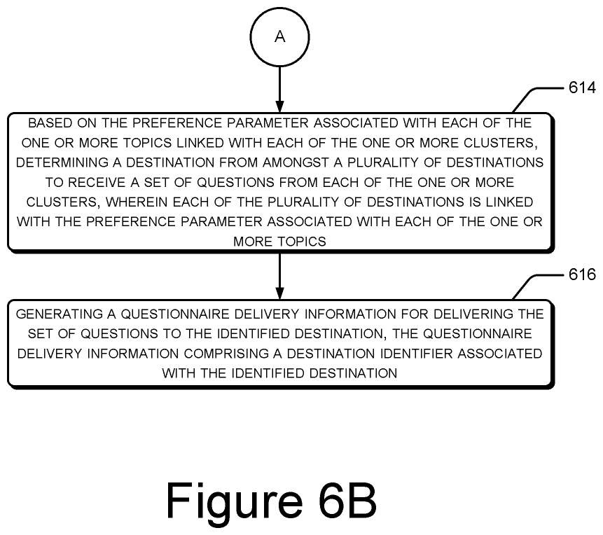

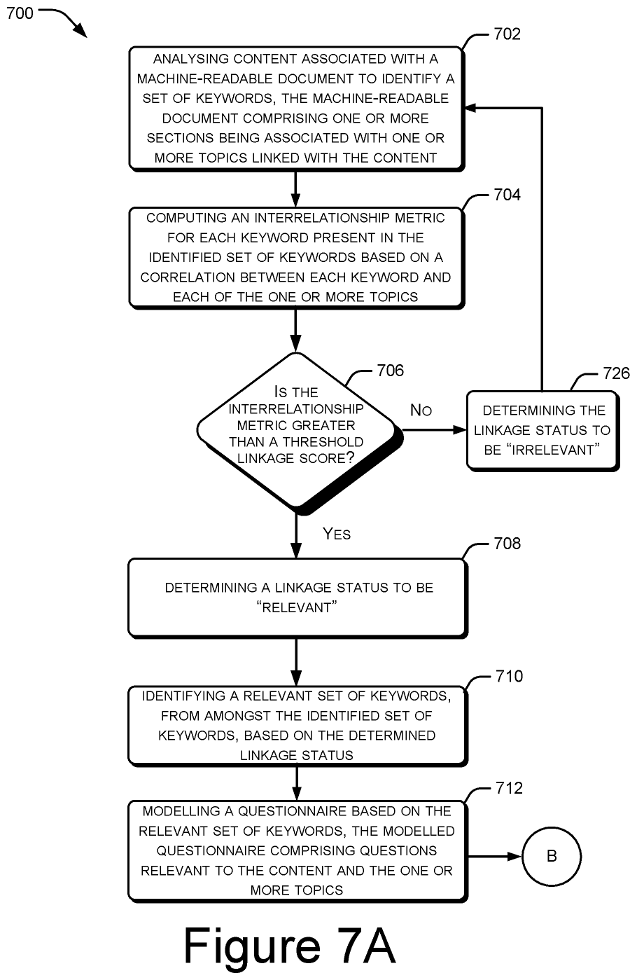

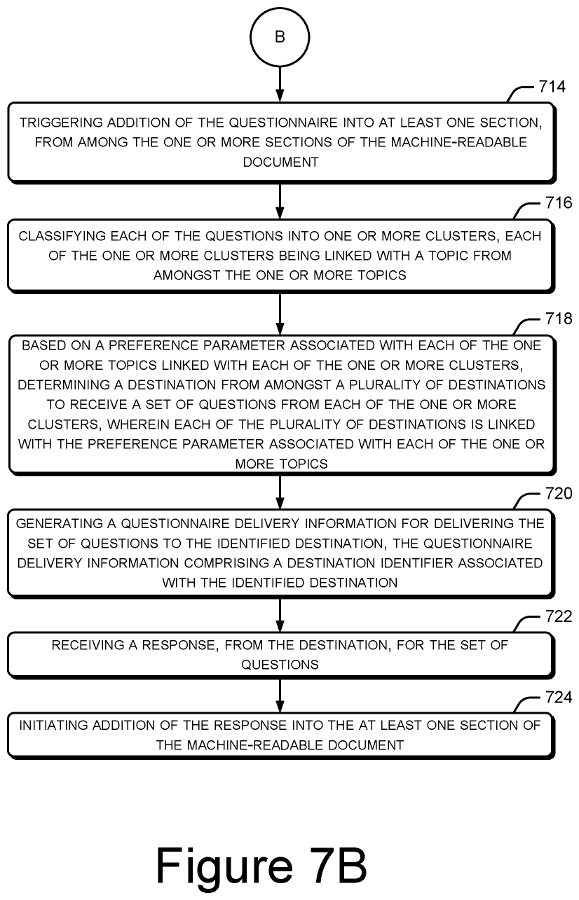

FIGS. 6A to 7B illustrate exemplary methods 600 and 700, respectively, for assisting in generation of content and identification of a destination for the generated content. The order in which the methods are described is not intended to be construed as a limitation, and any number of the described method blocks may be combined in any order to implement the methods, or an alternative method. Furthermore, methods 600 and 700 may be implemented by processing resource or computing device(s) through any suitable hardware, non-transitory machine-readable instructions, or combination thereof.

It may also be understood that methods 600 and 700 may be performed by programmed computing devices, such as the processor 104, as depicted in FIGS. 1A-4. Furthermore, the methods 600 and 700 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. While the methods 600 and 700 are described below with reference to the processor 104 and the system 102 as described above; other suitable systems for the execution of these methods may also be utilized. Additionally, implementation of these methods is not limited to such examples.

FIGS. 6A and 6B illustrate the method 600 for assisting generation of content and identification of the destination for the generated content, according to an example implementation of the present subject matter.

At block 602, content associated with a machine-readable document may be analysed to identify a set of keywords. The machine-readable document, in one example, comprises one or more sections being associated with one or more topics linked with the content. Further, each of the one or more topics may have a preference parameter associated therewith.

At block 604, an interrelationship metric may be computed for each keyword present in the identified set of keywords. In one example, the interrelationship metric may be computed based on a correlation between each keyword and each of the one or more topics.

At block 606, a linkage status for each keyword present in the identified set of keywords may be determined. In one example, the linkage status may indicate a potential relationship between each keyword, present in the identified set of keywords, and a topic, from amongst the one or more topics. The linkage status may be determined based on a comparison between the interrelationship metric computed for each keyword present in the identified set of keywords and a threshold linkage score.

At block 608, a relevant set of keywords may be identified from amongst the identified set of keywords. In one example, the identification may be based on the determined linkage status. For example, keywords for which the linkage status may have been ascertained to be linkable, may be added to the relevant set of keywords.

At block 610, a questionnaire may be modelled based on the relevant set of keywords. The modelled questionnaire may include questions relevant to the content and the one or more topics.

At block 612, each of the questions may be classified into one or more clusters, where each of the one or more clusters may be linked with a topic from amongst the one or more topics. The method may then continue from block A.

From block A and at block 614, a destination may be determined from amongst a plurality of destinations to receive a set of questions from each of the one or more clusters. In one example, each of the plurality of destinations may be linked with the preference parameter associated with each of the one or more topics. Based on the preference parameter associated with each of the plurality of destinations and the preference parameter associated with one or more topics linked with each of the one or more clusters, the destination may accordingly be determined.

At block 616, a questionnaire delivery information may be generated for delivering the set of questions to the identified destination. In one example, the questionnaire delivery information comprises a destination identifier associated with the identified destination.

FIGS. 7A and 7B illustrate the method 700 for generating content and identification of the destination for the generated content, according to another example implementation of the present subject matter.

At block 702, content associated with a machine-readable document may be analysed to identify a set of keywords. The machine-readable document, in one example, comprises one or more sections being associated with one or more topics linked with the content. In one example, the content, such as the content 202, associated with the machine-readable document, such as the document 200, may be analysed to identify the set of keywords. The set of keywords may be, for example, frequently present in the content. Further, each of the one or more topics may have a preference parameter associated therewith. In one example, the preference parameter associated with each of the one or more topics may indicate a magnitude of criticality associated with each of the one or more topics.

At block 704, an interrelationship metric for each keyword present in the identified set of keywords may be computed based on a correlation between each keyword and each of the one or more topics linked to the content. In one example, the interrelationship metric may be determined to ascertain which of the keywords may be correlated to which of the one or more topics linked to the content. To determine correlation, different correlation determination techniques may be used. Examples of the techniques may include, but are not limited to, cosine similarity, Jaccard similarity, and Pearson correlation. In another example, specialized tools or programming libraries may be. Examples of the libraries may include, but are not limited to, Natural Language Toolkit (NLTK), spaCy, and topic modelling libraries.

In one example, the interrelationship metric may be a score quantifying the correlation. For example, a keyword being correlated to a topic may have a higher score as compared to another keyword that may not be correlated with the topic. Further, the correlation may be at least one of a simple correlation and a complex correlation. In the simple correlation, each keyword present in the identified set of keywords may have a direct relationship with at least one of the one or more topics. Whereas, in complex correlation, each keyword may be correlated with at least one intermediary keyword present in the identified set of keywords, where the at least one intermediary keyword may create a linked relationship with at least one of the one or more topics. The at least one intermediary keyword may thus create a linked relationship with at least one of the one or more topics.

At block 706, it may be determined whether the interrelationship metric is greater than a threshold linkage score. In one example, the threshold linkage score may be a pre-defined score. The threshold linkage score may be dynamically defined, in one example, by the expert individual. In another example, the threshold linkage score may be automatically determined. For example, the threshold linkage score may be determined based on an average of the interrelationship metrics computed for the all keywords present in the identified set of keywords. If the interrelationship metric is determined to be greater than the threshold linkage score, the method may follow the Yes path to block 708.

At block 708, it may be determined that a linkage status is “relevant”. In one example, the linkage status for each keyword present in the identified set of keywords may be determined. The linkage status may indicate a potential relevance between each keyword, present in the identified set of keywords, and each of the one or more topics. If the interrelationship metric for a keyword is greater than the threshold linkage score, that the keyword may be linkable or relevant to at least one of the one or more topics. The linkage status for that keyword may be determined to be “relevant”.

At block 710, a relevant set of keywords, from amongst the identified set of keywords, may be identified. In one example, the identification may be based on the determined linkage status. For example, the keywords for which the linkage status is determined to be “relevant”, such keywords may be added to the relevant set of keywords.

At block 712, a questionnaire may be modelled based on the relevant set of keywords. The modelled questionnaire may include questions relevant to the content and the one or more topics. Algorithms and/or pre-trained language models may be used to understand semantics of the relevant set of keywords, allowing them to generate the questions. For example, natural language processing (NLP) techniques to identify key information, patterns, and context to formulate relevant questions. The method may then continue from block B.

From block B and at block 714, addition of the questionnaire into at least one section, from among the one or more sections of the machine-readable document, may be triggered. In one example, the modelled questionnaire may be added in section 204-N of the document 200.

At block 716, each of the questions may be classified into one or more clusters, where each of the one or more clusters may be linked with a topic from amongst the one or more topics. In one example, text present in each of the questions of the questionnaire may be analysed to ascertain relevance of each of the questions with the at least one of the one or more topics. Based on the relevance, each of the questions may be classified into the one or more clusters. In one example, topic modelling may be performed for each of the questions to analyse and classify each of the questions into one or more clusters, based on a determination of the topic with which the questions may be associated.

At block 718, a destination may be determined from amongst a plurality of destinations to receive a set of questions from each of the one or more clusters. In one example, each of the plurality of destinations may be linked with the preference parameter associated with each of the one or more topics. Based on the preference parameter associated with each of the plurality of destinations and the preference parameter associated with one or more topics linked with each of the one or more clusters, the destination may accordingly be determined. Since each of the preference parameters is associated with the one or more topics (as illustrated in FIG. 5B), and the one or more topics may be linked with the one or more clusters (as illustrated in FIG. 5D), each of the plurality of destinations may be linked to the one or more clusters. Thus, a destination, from amongst the destinations 108, may be identified to receive the set of questions associated with the one or more clusters.

At block 720, a questionnaire delivery information may be generated for delivering the set of questions to the identified destination. The questionnaire delivery information may include a destination identifier associated with the identified destination. In one example, the questionnaire delivery information may be a signal including a destination identifier associated with the identified destination. The destination identifier may include a unique identification indicator associated with the destination, such as the 108-1, for identifying the destination. The unique identification indicator may be, for example, an email address associated with the identified destination. In one example, the destination may be the expert individual. Based on the questionnaire delivery information, the set of questions may be routed and delivered to the identified destination.

At block 722, a response may be received from the destination for the set of questions. In one example, the set of questions my be rendered on a GUI. The GUI me include fields or options capable of receiving a response for the set of questions. The response may then be received for the set of questions.

At block 724, addition of the response into the at least one section of the machine-readable document may be initiated. In one example, a process may be initiated to add the received response into at least one section, such as the questionnaire section 204-N.

However, in one example, if at block 706, it is determined that the interrelationship metric is less than or equal to the threshold linkage score, the method may follow the No pat to block 726.

At block 726, it may be determined that the linkage status is “irrelevant”. If the interrelationship metric for a keyword is less than or equal to the threshold linkage score, that keyword may be irrelevant to at least one of the one or more topics. The linkage status for that keyword may be determined to be “irrelevant”, and the method may flow to block 702.

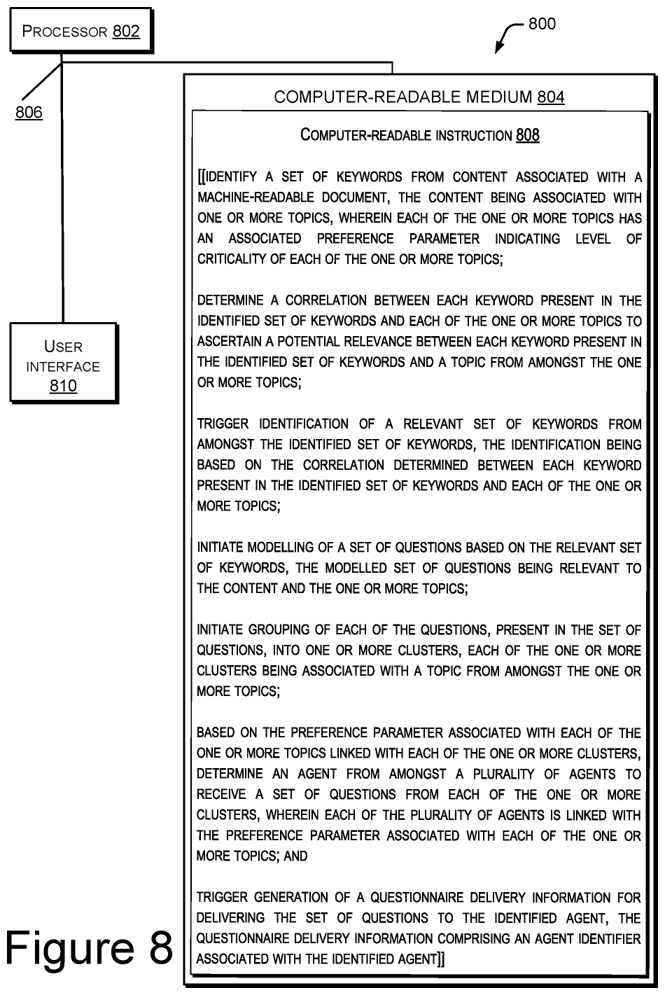

FIG. 8 illustrates a non-transitory computer-readable medium for generating, or at least assist in generation of, content and identifying a destination from amongst the plurality of destinations, in accordance with an example of the present subject matter.

In an example, the computing environment 800 includes a processor 802 communicatively coupled to a non-transitory computer readable medium 804 through communication link 806. In an example, the processor 802 may have one or more processing resources for fetching and executing computer-readable instructions from the non-transitory computer readable medium 804. The processor 802 and the non-transitory computer readable medium 804 may be implemented, for example, in the system 102.

The non-transitory computer readable medium 804 may be, for example, an internal memory device or an external memory. In an example implementation, the communication link 806 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 804 includes a set of computer readable instructions 808 which may be accessed by the processor 802 through the communication link 806 and subsequently executed for reconfiguring the data pipeline. The processor 802 and the non-transitory computer r readable medium 804 may also be communicatively coupled to a user interface 810 over the network communication link 806. In one example, the user interface 810 may be a GUI interface.

Referring to FIG. 8, in an example, the non-transitory computer readable medium 804 includes computer readable instructions 808 that may cause the processor 802 to identify a set of keywords from content associated with a machine-readable document, such as the document 200. In one example, the content, such as the content 202, may be associated with one or more topics, where each of the one or more topics has an associated preference parameter indicating level of criticality of each of the one or more topics. Further, the instructions 808 may further cause the processor 802 to parse the content 202 associated with the machine-readable document 200 to identify the set of keywords. In one example, the set of keywords may include the most common keywords present in the content 202. For example, the identified set of keywords may include one or more keywords present in the content 202 for a number of times more than a keyword identification threshold. In one example, the keyword identification threshold may define a minimum number of times for which the keyword must be present in the content 202 for being added in the identified set of keywords. In one example, value of the keyword identification threshold may be defined by the expert individual.

The instructions 808 may further cause the processor 802 to determine a correlation between each keyword present in the identified set of keywords and each of the one or more topics to ascertain a potential relevance between each keyword present in the identified set of keywords and a topic from amongst the one or more topics. In one example, the correlation may be at least one of a simple correlation and a complex correlation. In the simple correlation, each keyword present in the identified set of keywords has a direct relationship with at least one of the one or more topics. Whereas, in the complex correlation, each keyword is correlated with at least one intermediary keyword present in the identified set of keywords, where the at least one intermediary keyword may create a linked relationship with at least one of the one or more topics.

The instructions 808 may further cause the processor 802 to trigger identification of a relevant set of keywords from amongst the identified set of keywords. In one example, the identification may be based on the correlation determined between each keyword present in the identified set of keywords and each of the one or more topics.

The instructions 808 may further cause the processor 802 to initiate modelling of a set of questions, based on the relevant set of keywords, being relevant to the content and the one or more topics. Since the questions may be modelled based on the relevant set of keywords, that may be most commonly appearing in the content 202 and that may be correlated with the one or more topics, the probability of modelling the questions relevant to the content 202 and the one or more topics may improve. In one example, the processor 802 may be configured to model the set of questions based on the relevant set of keywords. In another example, the processor 802 may initiate modelling of the set of questions, by communicating with an external question generator, for example the content generation unit 412 that may be communicably coupled with the processor 802.

The instructions 808 may further cause the processor 802 to initiate grouping of each of the questions, present in the set of questions, into one or more clusters, where each of the one or more clusters may be associated with a topic from amongst the one or more topics. In one example, each of the questions in the set of questions may be classified based on the topics to which they related. Question relating to same topics may be grouped into same clusters.

The instructions 808 may further cause the processor 802 to determine an agent from amongst a plurality of agents to receive a set of questions from each of the one or more clusters, where each of the plurality of agents may be linked with the preference parameter associated with each of the one or more topics. Examples of the agents may include, but are not limited to, machine learning models, artificial intelligence-based models, and deep learning-based models. In one example, the agents may be the expert individuals.

In one example, each of the plurality of agents may be linked with the preference parameter associated with each of the one or more topics. Based on the preference parameter linked with each of the plurality of agents and the preference parameter associated with one or more topics linked with each of the one or more clusters, the agent may accordingly be determined. Since each of the preference parameters is associated with the one or more topics, and the one or more topics may be linked with the one or more clusters, each of the plurality of agents may be linked to the one or more clusters. Thus, the suitable agent, from amongst the plurality of agents, may be identified to receive the set of questions associated with the one or more clusters.

The instructions 808 may further cause the processor 802 to trigger generation of a questionnaire delivery information for delivering the set of questions to the identified agent. In one example, the questionnaire delivery information may include an agent identifier associated with the identified agent. In one example, the agent identifier may be a unique information associated with each of the models. In another example, the agent identifier may be an email address associated with the identified agent. Based on the questionnaire delivery information the set of questions may be routed and delivered to the identified agent.

The instructions 808 may further cause the processor 802 to cause rendering of the set of questions on at least one user interface, such as the user interface 810 associated with the identified agent. In one example, the agent may be the expert individual.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system comprising:
a processor to:
parse content associated with a machine-readable document to identify a set of keywords, the machine-readable document comprising one or more sections associated with one or more topics linked to the content, wherein each of the one or more topics has a preference parameter associated therewith and indicating a significance of each of the one or more topics;
compute an interrelationship metric for each keyword present in the identified set of keywords based on a correlation between each keyword and each of the one or more topics, the correlation being at least one of a simple correlation and a complex correlation, wherein, in the simple correlation, each keyword present in the identified set of keywords has a direct relationship with at least one of the one or more topics, and wherein, in the complex correlation, each keyword is correlated with at least one intermediary keyword present in the identified set of keywords, the at least one intermediary keyword creating a linked relationship with at least one of the one or more topics;
determine a linkage status for each keyword present in the identified set of keywords, the linkage status indicating a potential relevance between each keyword present in the identified set of keywords and at least one of the one or more topics, the linkage status being determined based on a comparative assessment between the interrelationship metric computed for each keyword present in the identified set of keywords and a threshold linkage score;
filter a relevant set of keywords, from amongst the identified set of keywords, based on the linkage status determined for each keyword present in the identified set of keywords;
trigger modelling of a questionnaire based on the relevant set of keywords, the modelled questionnaire comprising questions relevant to the content and the one or more topics;
initiate classification of each of the questions into one or more clusters, each of the one or more clusters being linked with a topic from amongst the one or more topics;
identify a destination from amongst a plurality of destinations to receive a set of questions from the one or more clusters, the identification of the destination being based on the preference parameter, wherein each of the plurality of destinations is linked with the preference parameter associated with each of the one or more topics linked with at least one of the one or more clusters; and
generate a questionnaire delivery information for delivering the set of questions to the identified destination, the questionnaire delivery information comprising a destination identifier associated with the identified destination.

2. The system of claim 1, wherein the processor is further configured to identify the destination based on historical destination information comprising a mapping table indicating a relationship between the one or more clusters linked to the one or more topics, the preference parameter associated with each of the one or more topics, and the plurality of destinations associated with the preference parameter.

3. The system of claim 1, wherein the content comprises at least one of text, tables, one or more images, one or more graphs, and a combination thereof.

4. The system of claim 1, further comprising:
a data repository communicably coupled with the processor, wherein the data repository is to store the content associated with the machine-readable document; and
an interface generation unit communicably coupled with the processor, wherein the interface generation unit is configured to:
initiate rendering of the set of questions on the destination; and
cause receiving of a response for the set of questions from the destination.

5. The system of claim 1, wherein the processor is further configured to receive a response, for the set of questions, from the destination.

6. The system of claim 1, wherein the processor is further configured to trigger addition of the set of questions into at least one section, from amongst the one or more sections of the machine-readable document.

7. The system of claim 1, wherein the processor is further configured to:
parse the questions present in the questionnaire to ascertain relevance of each of the questions with at least one of the one or more topics; and
based on the relevance, classify each of the questions into the one or more clusters.

8. The system of claim 1, wherein the destination identifier comprises a unique identification indicator associated with the destination for identifying the destination.

9. The system of claim 1, wherein the questionnaire delivery information further comprises a duration indication for indicating a time period for receiving a response from the destination.

10. A method comprising:
analysing content associated with a machine-readable document to identify a set of keywords, the machine-readable document comprising one or more sections being associated with one or more topics linked with the content, wherein each of the one or more topics has a preference parameter associated therewith;
computing an interrelationship metric for each keyword present in the identified set of keywords based on a correlation between each keyword and each of the one or more topics;
determining a linkage status for each keyword present in the identified set of keywords, the linkage status indicating a potential relationship between each keyword present in the identified set of keywords and a topic from amongst the one or more topics, the linkage status being determined based on a comparison between the interrelationship metric computed for each keyword present in the identified set of keywords and a threshold linkage score;
identifying a relevant set of keywords, from amongst the identified set of keywords, based on the determined linkage status;
modelling a questionnaire based on the relevant set of keywords, the modelled questionnaire comprising questions relevant to the content and the one or more topics;
classifying each of the questions into one or more clusters, each of the one or more clusters being linked with a topic from amongst the one or more topics;
based on the preference parameter associated with each of the one or more topics linked with each of the one or more clusters, determining a destination from amongst a plurality of destinations to receive a set of questions from each of the one or more clusters, wherein each of the plurality of destinations is linked with the preference parameter associated with each of the one or more topics; and
generating a questionnaire delivery information for delivering the set of questions to the identified destination, the questionnaire delivery information comprising a destination identifier associated with the identified destination.

11. The method of claim 10, wherein the preference parameter associated with each of the one or more topics indicates a magnitude of criticality associated with each of the one or more topics.

12. The method of claim 10, wherein the correlation is at least one of a simple correlation and a complex correlation, wherein, in the simple correlation, each keyword present in the identified set of keywords has a direct relationship with at least one of the one or more topics, and wherein, in the complex correlation, each keyword is correlated with at least one intermediary keyword present in the identified set of keywords, the at least one intermediary keyword creating a linked relationship with at least one of the one or more topics.

13. The method of claim 10, the method further comprising triggering addition of the questionnaire into at least one section, from among the one or more sections of the machine-readable document.

14. The method of claim 13, the method further comprising:
receiving a response, from the destination, for the set of questions; and
initiating addition of the response into the at least one section of the machine-readable document.

15. The method of claim 10, the method further comprising:
analysing text present in each of the questions of the questionnaire to ascertain relevance of each of the questions with the at least one of the one or more topics; and
based on the relevance, classifying each of the questions into the one or more clusters.

16. A non-transitory computer-readable medium comprising instructions being executable by a processing resource to:
identify a set of keywords from content associated with a machine-readable document, the content being associated with one or more topics, wherein each of the one or more topics has an associated preference parameter indicating level of criticality of each of the one or more topics;
determine a correlation between each keyword present in the identified set of keywords and each of the one or more topics to ascertain a potential relevance between each keyword present in the identified set of keywords and a topic from amongst the one or more topics;
trigger identification of a relevant set of keywords from amongst the identified set of keywords, the identification being based on the correlation determined between each keyword present in the identified set of keywords and each of the one or more topics;
initiate modelling of a set of questions based on the relevant set of keywords, the modelled set of questions being relevant to the content and the one or more topics;
initiate grouping of each of the questions, present in the set of questions, into one or more clusters, each of the one or more clusters being associated with a topic from amongst the one or more topics;
based on the preference parameter associated with each of the one or more topics linked with each of the one or more clusters, determine an agent from amongst a plurality of agents to receive a set of questions from each of the one or more clusters, wherein each of the plurality of agents is linked with the preference parameter associated with each of the one or more topics; and
trigger generation of a questionnaire delivery information for delivering the set of questions to the identified agent, the questionnaire delivery information comprising an agent identifier associated with the identified agent.

17. The non-transitory computer-readable medium of claim 16, wherein the correlation is at least one of a simple correlation and a complex correlation, wherein, in the simple correlation, each keyword present in the identified set of keywords has a direct relationship with at least one of the one or more topics, and wherein, in the complex correlation, each keyword is correlated with at least one intermediary keyword present in the identified set of keywords, the at least one intermediary keyword creating a linked relationship with at least one of the one or more topics.

18. The non-transitory computer-readable medium of claim 16, wherein the instructions are executed by the processing resource to parse the content associated with the machine-readable document to the identify the set of keywords.

19. The non-transitory computer-readable medium of claim 16, wherein the identified set of keywords comprises one or more keywords present, in the content, for a number of times more than a keyword identification threshold.

20. The non-transitory computer-readable medium of claim 16, wherein the instructions are executed by the processing resource to cause rendering of the set of questions on at least one user interface associated with the agent.
